(19) United States
(12) Patent Application Publication
(10) Pub. No.: US 2012/0136619 A1
(43) Pub. Date: May 31, 2012

(54) COLLISION DETECTING METHOD, ELECTRONIC DEVICE, AND COMPUTER PROGRAM PRODUCT THEREOF

(75) Inventors: Chung-Ming Huang, Kaohsiung City (TW); Lai Tu, Hubei (CN); Shih-Yang Lin, Changhua County (TW); Cheng-Jung Lin, Taipei County (TW); Ming-Da Lee, Taipei County (TW); Yi-Hong Chu, Taipei City (TW)

(73) Assignee: INSTITUTE FOR INFORMATION INDUSTRY, Taipei (TW)

(21) Appl. No.: 12/960,562

(22) Filed: Dec. 6, 2010

(30) Foreign Application Priority Data
Nov. 25, 2010 (TW) 99140820

(51) Int. Cl. G06F 15/00; G01P 15/00

(52) U.S. Cl. 702/141

(57) ABSTRACT

A collision detecting method, an electronic device, and a computer program product thereof are provided for the electronic device having an accelerometer, a positioning module, and a communication module. The method includes obtaining a plurality of acceleration variations within each of a plurality of sampling intervals respectively detected by the accelerometer. The method also includes transforming the corresponding acceleration variations into a plurality of frequency domain signals for each sampling interval, and calculating energy and entropy of the frequency domain signals. The method further includes determining a collision has occurred if the energy and the entropy corresponding to each of a plurality of specific sampling intervals among the sampling intervals both drastically increase then drastically decrease suddenly.

### CROSS-REFERENCE TO RELATED APPLICATION

This application claims the priority benefit of Taiwan application serial no. 99140820, filed on Nov. 25, 2010. The entirety of the above-mentioned patent application is hereby incorporated by reference herein and made a part of this specification.

### BACKGROUND

1. Field of the Invention

The invention relates to a collision detecting method. Particularly, the invention relates to a collision detecting method without limiting collided objects, and an electronic device and a computer program product executing the same.

2. Description of Related Art

Collisions caused by traffic accidents, falls or other accidents always result in unconsciousness or even life-threatening of people. In order to facilitate a post-treatment of the accident, a detecting technique of the accident gradually becomes important.

In various accident injuries, a life-threatening degree caused by the collision of the traffic accident is extremely high, so that many collision detecting techniques have been applied in driving security systems. Generally, collision detecting devices used in vehicles mainly make decisions according to acceleration variations. Namely, the acceleration variation of the vehicle is compared to a predetermined threshold, and it is determined that a collision has occurred when the acceleration variation is greater than the predetermined threshold. Therefore, under such determination mechanism, a value of the threshold may directly influence a determination result. In case of an excessively low threshold, the collision detecting device may misjudge occurrence of a collision when the vehicle passes through a hole or a bump in the road, and in case of an excessively high threshold, detection of an actual collision is probably missed.

In order to avoid misjudgment caused by falling of the device, the determination mechanism is activated only when a speed of the vehicle exceeds a predetermined value and last for a period of time. Therefore, when the vehicle in a low speed or in a static state is collided, the collision cannot be detected since the speed of the vehicle does not reach the threshold value.

Most of the current collision detecting techniques relate to collisions between vehicles. However, besides the traffic accidents, hazards of life safety caused by collisions of the other types of accidents cannot be ignored. Therefore, how to effectively detect collisions occurred under various circumstances and improve efficiencies of post-treatments after the collisions are important issues to be developed by related technicians.

### SUMMARY OF THE INVENTION

Accordingly, the invention is directed to a collision detecting method, by which whether a person or a vehicle is collided under various circumstances can be effectively and accurately determined.

The invention is directed to an electronic device, which can be carried around or disposed in a vehicle, and can accurately determine occurrence of a collision.

The invention is directed to a computer program product, which can not only reduce a chance of misjudging a collision, but can also opportunely send a notification message after the collision is occurred.

The invention provides a collision detecting method, adapted to an electronic device having an accelerometer, a positioning module, and a communication module. The method includes obtaining a plurality of acceleration variations within each of a plurality of sampling intervals respectively detected by the accelerometer. The method also includes transforming the corresponding acceleration variations into a plurality of frequency domain signals under a frequency domain for each of the sampling intervals, and calculating energy and entropy of the frequency domain signals. The method further includes determining a collision has occurred when the energy and the entropy corresponding to each of a plurality of specific sampling intervals among the sampling intervals both drastically increase then drastically decrease suddenly.

In an embodiment of the invention, the collision detecting method further includes determining whether a number of the sampling intervals is greater than or equal to 3, and taking latest three adjacent sampling intervals among the sampling intervals as the specific sampling intervals when the number of the sampling intervals is greater than or equal to 3, and determining whether the energy and the entropy corresponding to each of the specific sampling intervals both drastically increase then drastically decrease suddenly.

In an embodiment of the invention, the latest three adjacent sampling intervals are respectively an (i−1)^{th} sampling interval, an i^{th} sampling interval and an (i+1)^{th} sampling interval, where i is a positive integer greater than 1. The step of determining whether the energy and the entropy corresponding to each of the specific sampling intervals both drastically increase then drastically decrease suddenly includes calculating a first statistic value according to the energy corresponding to the (i−1)^{th} sampling interval and the energy corresponding to the (i+1)^{th} sampling interval; calculating a second statistic value according to the entropy corresponding to the (i−1)^{th} sampling interval and the entropy corresponding to the (i+1)^{th} sampling interval; determining whether the energy corresponding to the i^{th} sampling interval is greater than a first threshold, and whether the entropy corresponding to the i^{th} sampling interval is greater than a second threshold; and if yes, determining the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic, and an increasing rate between the entropy corresponding to the i^{th} sampling interval and the entropy corresponding to the (i−1)^{th} sampling interval is greater than a third threshold.

In an embodiment of the invention, the step of transforming the corresponding acceleration variations into the frequency domain signals under the frequency domain for each of the sampling intervals includes executing a time domain/frequency domain transform process to the acceleration variations to generate the frequency domain signals.

In an embodiment of the invention, the time domain/frequency domain transform process includes one of a Fourier transform process, a cosine transform process, a sine transform process and a wavelet transform process.

In an embodiment of the invention, the adjacent sampling intervals among the sampling intervals are partially overlapped.

In an embodiment of the invention, after the step of determining the collision has occurred, the collision detecting method further includes obtaining position information of the electronic device through the positioning module, and sending a message carrying the position information through the communication module.

According to another aspect, the invention provides an electronic device including an accelerometer, a positioning module, a communication module and a processing module. The processing module is coupled to the accelerometer, the positioning module and the communication module. The processing module is used for obtaining a plurality of acceleration variations within each of a plurality of sampling intervals respectively detected by the accelerometer, for each of the sampling intervals, transforming the corresponding acceleration variations into a plurality of frequency domain signals under a frequency domain and calculating energy and entropy of the frequency domain signals. The processing module further determines that a collision has occurred when the energy and the entropy corresponding to each of a plurality of specific sampling intervals among the sampling intervals both drastically increase then drastically decrease suddenly.

In an embodiment of the invention, the processing module determines whether a number of the sampling intervals is greater than or equal to 3, takes latest three adjacent sampling intervals among the sampling intervals as the specific sampling intervals when the number of the sampling intervals is greater than or equal to 3, and determines whether the energy and the entropy corresponding to each of the specific sampling intervals both drastically increase then drastically decrease suddenly.

In an embodiment of the invention, the latest three adjacent sampling intervals are respectively an (i−1)^{th} sampling interval, an i^{th} sampling interval and an (i+1)^{th} sampling interval, where i is a positive integer greater than 1. The processing module calculates a first statistic value according to the energy corresponding to the (i−1)^{th} sampling interval and the energy corresponding to the (i+1)^{th} sampling interval, calculates a second statistic value according to the entropy corresponding to the (i−1)^{th} sampling interval and the entropy corresponding to the (i+1)^{th} sampling interval, and determines whether the energy corresponding to the i^{th} sampling interval is greater than a first threshold, and whether the entropy corresponding to the i^{th} sampling interval is greater than a second threshold. If yes, the processing module determines the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic value, and an increasing rate between the entropy corresponding to the i^{th} sampling interval and the entropy corresponding to the (i−1)^{th} sampling interval is greater than a third threshold.

In an embodiment of the invention, the processing module executes a time domain/frequency domain transform process to the corresponding acceleration variations to generate the frequency domain signals for each of the sampling intervals.

In an embodiment of the invention, the time domain/frequency domain transform process includes one of a Fourier transform process, a cosine transform process, a sine transform process and a wavelet transform process.

In an embodiment of the invention, the adjacent sampling intervals among the sampling intervals are partially overlapped.

In an embodiment of the invention, after the processing module determines that the collision has occurred, the processing module controls the positioning module to obtain position information of the electronic device, and controls the communication module to send a message carrying the position information.

The invention provides a computer program product including at least one program instruction, the program instructions are located into an electronic device having an accelerometer, a positioning module, and a communication module for executing following steps: obtaining a plurality of acceleration variations within each of a plurality of sampling intervals respectively detected by the accelerometer; for each of the sampling intervals, transforming the corresponding acceleration variations into a plurality of frequency domain signals under a frequency domain and calculating energy and entropy of the frequency domain signals; and determining a collision has occurred when the energy and the entropy corresponding to each of a plurality of specific sampling intervals among the sampling intervals both drastically increase then drastically decrease suddenly.

In an embodiment of the invention, the program instructions further determine whether a number of the sampling intervals is greater than or equal to 3, and take latest three adjacent sampling intervals among the sampling intervals as the specific sampling intervals when the number of the sampling intervals is greater than or equal to 3, and determine whether the energy and the entropy corresponding to each of the specific sampling intervals both drastically increase then drastically decrease suddenly.

In an embodiment of the invention, the latest three adjacent sampling intervals are respectively an (i−1)^{th} sampling interval, an i^{th} sampling interval and an (i+1)^{th} sampling interval, where i is a positive integer greater than 1. When the program instructions determine whether the energy and the entropy corresponding to each of the specific sampling intervals both drastically increase then drastically decrease suddenly, the program instructions calculate a first statistic value according to the energy corresponding to the (i−1)^{th} sampling interval and the energy corresponding to the (i+1)^{th} sampling interval, calculate a second statistic value according to the entropy corresponding to the (i−1)^{th} sampling interval and the entropy corresponding to the (i+1)^{th} sampling interval, determine whether the energy corresponding to the i^{th} sampling interval is greater than a first threshold, and whether the entropy corresponding to the i^{th} sampling interval is greater than a second threshold. If yes, the program instructions determine the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic value, and an increasing rate between the entropy corresponding to the i^{th} sampling interval and the entropy corresponding to the (i−1)^{th} sampling interval is greater than a third threshold.

In an embodiment of the invention, when the program instructions transform the corresponding acceleration variations into the frequency domain signals under the frequency domain for each of the sampling intervals, the program instructions execute a time domain/frequency domain transform process to the acceleration variations to generate the frequency domain signals.

In an embodiment of the invention, the time domain/frequency domain transform process includes one of a Fourier transform process, a cosine transform process, a sine transform process and a wavelet transform process.

In an embodiment of the invention, the adjacent sampling intervals among the sampling intervals are partially overlapped.

In an embodiment of the invention, after the program instructions determine that the collision has occurred, the program instructions further obtain position information of the electronic device through the positioning module, and send a message carrying the position information through the communication module.

According to the above descriptions, after the accelerometer detects the acceleration variations of the electronic device, the acceleration variations are transformed into the frequency domain signals under the frequency domain, and then it is determined whether the collision has occurred according to a whole variation status of the frequency domain signals. In this way, misjudgment of a collision when the vehicle passes through an uneven road can be effectively avoided, and a correct decision can also be made when a person or a vehicle in a static state or a slow moving state is collided, so that collision determination results with high accuracy can be obtained under various circumstances.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic device according to an embodiment of the invention.

FIG. 2 is a flowchart illustrating a collision detecting method according to an embodiment of the invention.

FIG. 3 is a two-dimensional coordinate system constructed by energy and entropy according to an embodiment of the invention.

FIG. 4 is a flowchart illustrating a collision detecting method according to another embodiment of the invention.

### DETAILED DESCRIPTION OF DISCLOSED EMBODIMENTS

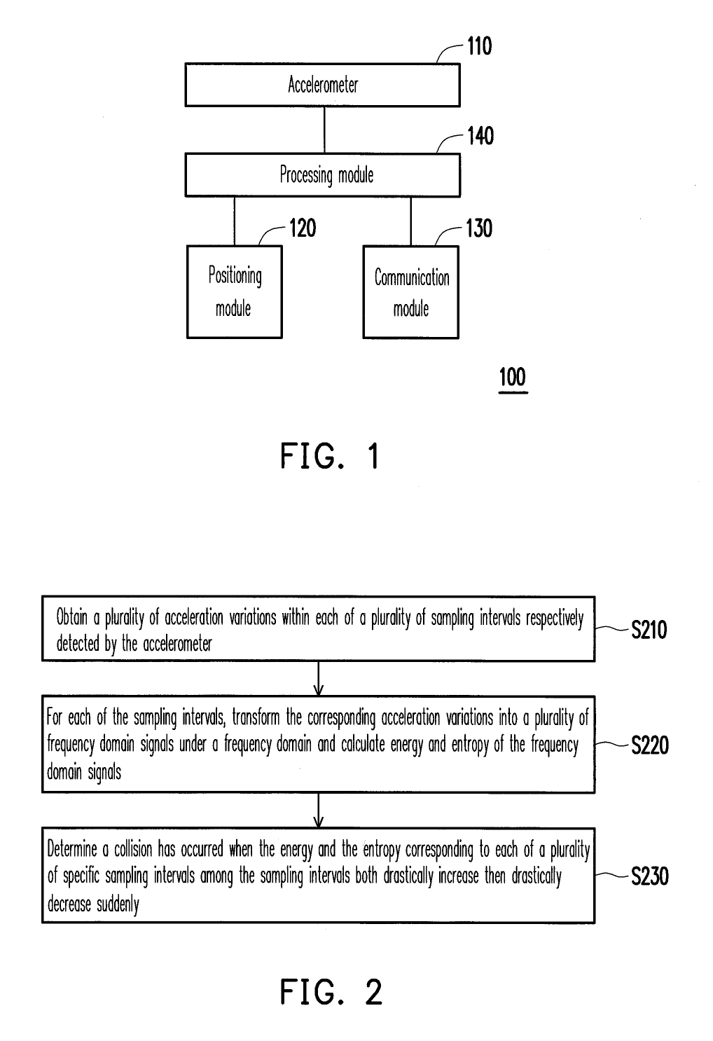

FIG. 1 is a block diagram illustrating an electronic device according to an embodiment of the invention. Referring to FIG. 1, the electronic device 100 includes an accelerometer 110, a positioning module 120, a communication module 130 and a processing module 140. The electronic device 100 can be a mobile device such as a mobile phone, a personal digital assistant (PDA) or a smart phone, etc., or a telematics system of a vehicle. In the invention, a type and a usage environment of the electronic device 100 are not limited.

The accelerometer 110 can be a G-sensor or an angular velocity sensor, which is used for detecting acceleration variations.

The positioning module 120 is, for example, a global positioning system (GPS), which is used for receiving satellite signals to calculate position information of the electronic device 100 in collaboration of an E-map.

The communication module 130 is, for example, a second generation telecommunication (2G) module, a third generation telecommunication (3G) module, a wireless fidelity (Wi-Fi) module, or a worldwide interoperability for microwave access (WiMAX) module, etc., which is used for providing a channel through which the electronic device 100 communicates with external.

The processing module 140 is coupled to the accelerometer 110, the positioning module 120 and the communication module 130. In the present embodiment, the processing module 140 can be a hardware device such as a chipset, etc., or can be implemented by program codes. The processing module 140 is especially used for executing a collision detecting mechanism, and transforming the acceleration variations detected by the accelerometer 110 into frequency domain signals under a frequency domain, and determining whether a collision has occurred according to a whole variation status of the frequency domain signals under the frequency domain.

In order to describe the collision detecting mechanism executed by the processing module 140 in detail, another embodiment is provided below for description. FIG. 2 is a flowchart illustrating a collision detecting method according to an embodiment of the invention.

Referring to FIG. 1 and FIG. 2, in step S210, the processing module 140 obtains a plurality of acceleration variations within each of a plurality of sampling intervals respectively detected by the accelerometer 110. In detail, the accelerometer 110 continually detects the acceleration variations after being started, and the processing module 140 taking the sampling interval as a unit to obtain all of the acceleration variations within each of the sampling intervals respectively detected by the accelerometer 110.

In order to fully grasp a variation status of the acceleration variations to avoid missing significant and representative variation patterns during sampling, in an embodiment, the adjacent sampling intervals are partially overlapped, though an overlapping rate thereof is not limited. For example, assuming that the accelerometer 110 detects the acceleration variation 50 times per second, and each of the sampling intervals is 5 seconds and the overlapping rate is 50%, the processing module 140 then obtains 250 acceleration variations for each of the sampling intervals. If an x^{th} acceleration variation detected by the accelerometer 110 is represented by Dₓ, the acceleration variations obtained by the processing module 140 during the first sampling interval are D₁ to D₂₅₀, and the acceleration variations obtained by the processing module 140 during the second sampling interval are D₁₂₆ to D₃₇₅, and analogically for the rest.

Then, in step S220, for each of the sampling intervals, the processing module 140 transforms all of the acceleration variations detected within the sampling interval into a plurality of frequency domain signals under a frequency domain, and calculates energy and entropy of the frequency domain signals. In detail, the processing module 140 executes a time domain/frequency domain transform process to the acceleration variations, so as to transform the acceleration variations obtained under a time domain into the frequency domain signals under the frequency domain. In the present embodiment, the time domain/frequency domain transform process executed by the processing module 140 is a Fourier transform process, so as to transform the acceleration variations into the frequency domain signals under a Fourier domain. In other embodiments, the time domain/frequency domain transform process executed by the processing module 140 may be a cosine transform process, a sine transform process or a wavelet transform process, etc., which is not limited by the invention. However, since a number of the frequency domain signals included in each of the sampling intervals is huge, in order to improve a computation efficiency for determining the collision, the processing module 140 may find characteristic values representing the variation status of all of the frequency domain signals within such sampling interval. In the present embodiment, the processing module 140 calculates the energy of the frequency domain signals for representing the mean of all of the frequency domains signals within such sampling interval, and calculates the entropy of the frequency domain signals for representing an information (i.e. signals) content ratio within such sampling interval, so as to filter noises. The processing module 140 can calculate the energy and the entropy according to a general frequency analysis method, which is not described therein.

According to a collision principle, when the collision is occurring, the energy and the entropy will increase suddenly, and after the collision, the energy and the entropy will decrease suddenly. Therefore, in step S230, if the energy and the entropy corresponding to each of a plurality of specific sampling intervals among the sampling intervals both drastically increase then drastically decrease suddenly, the processing module 140 determines that a collision has occurred. It should be noticed that the processing module 140 simultaneously supervises the energy and the entropy, and determines that the collision has occurred only when both of the energy and the entropy drastically increase then drastically decrease suddenly.

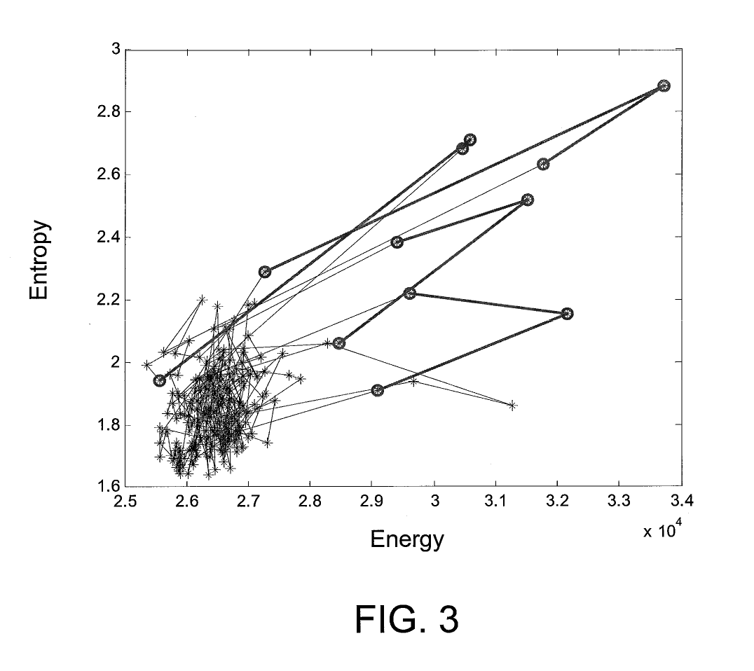

FIG. 3 is a two-dimensional coordinate system constructed by the energy and the entropy according to an embodiment of the invention, in which each point of the two-dimensional coordinate system represents a set of the energy and the entropy corresponding to a sampling interval. Assuming that the processing module 140 takes three adjacent sampling intervals as the specific sampling intervals, if a curve formed by the three sets of the energy and the entropy respectively corresponding to the three adjacent sampling intervals in the two-dimensional coordinate system is complied with a drastic fold-back pattern (which is represented by thick lines in FIG. 3), it represents a collision. Regarding the embodiment of FIG. 3, the processing module 140 determines that four collisions have occurred. It should be noticed that a criterion used for measuring whether the energy and the entropy drastically increase suddenly or drastically decrease suddenly relates to an object being collided detected by the electronic device 100. Generally, a range that the energy and the entropy are drastically increased suddenly or drastically decreased suddenly caused by a vehicle collision is greater than a range of that generated when a pedestrian is collided. Therefore, different criterions are used for determinations when the electronic device 100 is equipped in the vehicle for determining whether the vehicle is collided and when the electronic device 100 is carried by a user for determining whether the user is collided.

In the above embodiment, the processing module 140 will not directly use the acceleration variations detected by the accelerometer 110 to determine whether the collision has occurred, instead, the processing module 140 transforms the acceleration variations into the frequency domain signals under the frequency domain and then obtains the characteristic values such as the energy and the entropy. According to an experiment result, after the energy and the entropy corresponding to each of a plurality of the sampling intervals are calculated, if occurrence of the collision is determined only according to whether one of the energy and the entropy exceeds a specific value, it is very probable to make an incorrect determination. Therefore, the processing module 140 simultaneously supervises the variation status of the energy and the entropy, and accordingly determines whether the collision is occurred. In this way, the noises can be filtered to generate a collision determination result with high accuracy.

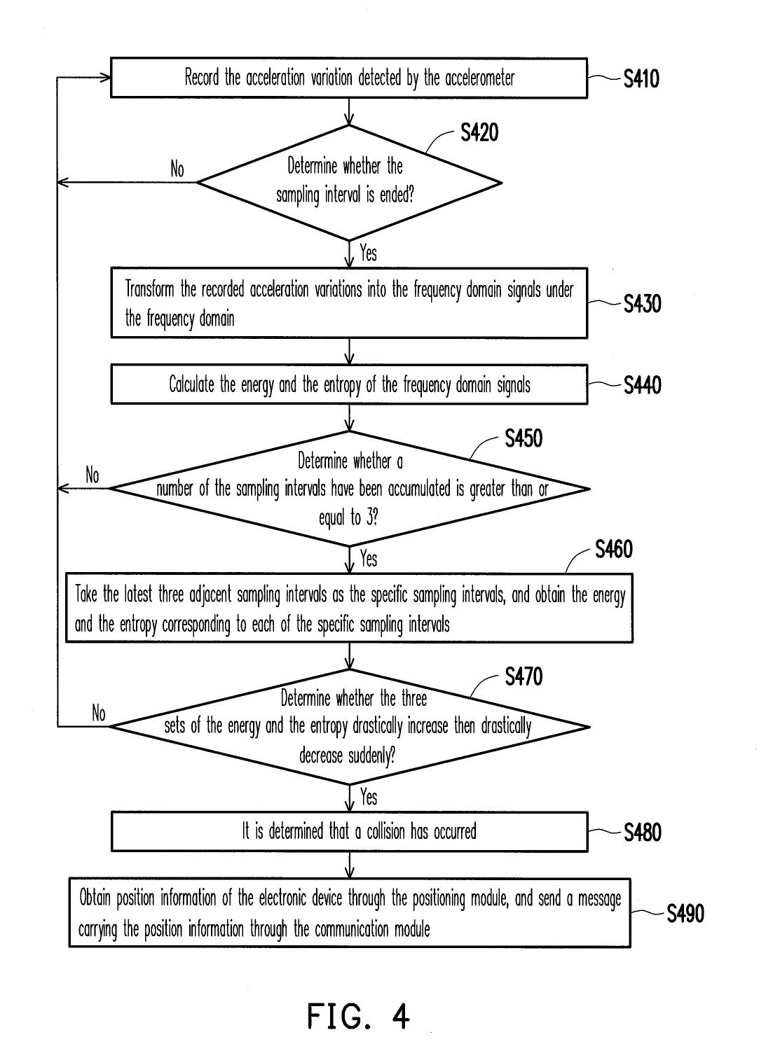

FIG. 4 is a flowchart illustrating a collision detecting method according to another embodiment of the invention. Referring to FIG. 4, in step S410, the acceleration variations detected by the accelerometer 110 are recorded. In step S420, it is determined that whether the sampling interval is ended. In the present embodiment, before the sampling interval is ended, the acceleration variations detected by the accelerometer 110 are continually collected and recorded.

Once the sampling interval is ended, in step S430, the processing module 140 transforms all of the acceleration variations recorded within such sampling interval into the frequency domain signals under the frequency domain. For example, the processing module 140 performs the Fourier transform process to all of the acceleration variations recorded within such sampling interval, so as to transform the acceleration variations into the frequency domain signals under the frequency domain. In step S440, the processing module 140 calculates the energy and the entropy of the frequency domain signals.

In step S450, the processing module 140 determines whether a number of sampling intervals have been accumulated is greater than or equal to 3, i.e. determines whether at least 3 sampling intervals have been lasted.

If the number of the sampling intervals have been accumulated is less than 3, the collision detecting method of the present embodiment is returned back to the step S410, by which the acceleration variations detected by the accelerometer 110 are continually collected and recorded. Conversely, if the number of the sampling intervals is greater than or equal to 3, in step S460, the processing module 140 takes the latest three adjacent sampling intervals among all of the sampling intervals as the specific sampling intervals, and obtains the energy and the entropy corresponding to each of the specific sampling intervals.

In step S470, the processing module 140 determines whether the obtained three sets of the energy and the entropy all drastically increase then drastically decrease suddenly. For simplicity's sake, the three specific sampling intervals are respectively represented by an (i−1)^{th} sampling interval, an i^{th} sampling interval and an (i+1)^{th} sampling interval, where i is a positive integer greater than 1.

In the present embodiment, the processing module 140 calculates a first statistic value according to the energy corresponding to the (i−1)^{th} sampling interval and the energy corresponding to the (i+1)^{th} sampling interval. For example, the processing module 140 takes an average of the energy corresponding to the (i−1)^{th} sampling interval and the energy corresponding to the (i+1)^{th} sampling interval as the first statistic value.

Moreover, the processing module 140 also calculates a second statistic value according to the entropy corresponding to the (i−1)^{th} sampling interval and the entropy corresponding to the (i+1)^{th} sampling interval. For example, the processing module 140 takes an average of the entropy corresponding to the (i−1)^{th} sampling interval and the entropy corresponding to the (i+1)^{th} sampling interval as the second statistic value.

When it is determined that whether the energy and the entropy corresponding to each of the specific sampling intervals drastically increase then drastically decrease suddenly, the processing module 140 first determines whether the energy corresponding to the i^{th} sampling interval is greater than a first threshold, and whether the entropy corresponding to the i^{th} sampling interval is greater than a second threshold. In an embodiment, the first threshold is 0.38 and the second threshold is 2, though the invention is not limited thereto.

If the energy corresponding to the i^{th} sampling interval is not greater than the first threshold, and/or the entropy corresponding to the i^{th} sampling interval is not greater than the second threshold, the processing module 140 does not perform following determination operations, and directly determines that the energy and the entropy corresponding to each of the three specific sampling intervals do not drastically increase then drastically decrease suddenly.

However, if the energy corresponding to the i^{th} sampling interval is greater than the first threshold and the entropy corresponding to the i^{th} sampling interval is greater than the second threshold, the processing module 140 determines whether the energy corresponding to the i^{th} sampling interval is greater than the first statistic value, whether the entropy corresponding to the i^{th} sampling interval is greater than the second statistic value, and whether an increasing rate between the entropy corresponding to the i^{th} sampling interval and the entropy corresponding to the (i−1)^{th} sampling interval is greater than a third threshold.

To be specific, if the energy corresponding to the i^{th} sampling interval is greater than the first statistic value, it represents that the energy corresponding to each of the three specific sampling intervals forms a convex wave. Similarly, if the entropy corresponding to the i^{th} sampling interval is greater than the second statistic value, it represents that the entropy corresponding to each of the three specific sampling intervals forms a convex wave. In an embodiment, the third threshold is, for example, 12%, though the invention is not limited thereto, and a value of the third threshold can be adjusted according to different experiment results.

The processing module 140 determines that the energy and the entropy corresponding to each of the three specific sampling intervals drastically increase then drastically decrease suddenly if the energy corresponding to the i^{th} sampling interval is greater than the first statistic value, the entropy corresponding to the i^{th} sampling interval is greater than the second statistic value, and the increasing rate between the entropy corresponding to the i^{th} sampling interval and the entropy corresponding to the (i−1)^{th} sampling interval is greater than the third threshold.

If the determination result of the step S470 is negative, the collision detecting method of the present embodiment is returned back to the step S410, by which the acceleration variations detected by the accelerometer 110 are continually collected and recorded. Conversely, if the determination result of the step S470 is affirmative, in step S480, the processing module 140 determines that a collision has occurred.

In step S490, the processing module 140 controls the positioning module 120 to obtain position information of the electronic device 100, and sends a message carrying the position information through the communication module 130, where such message can be a short message or a telephone call. Namely, after the processing module 140 determines that the collision has occurred, the electronic device 100 automatically sends the message carrying the position information to related departments, so as to improve a post-treatment efficiency.

As described above, after each of the sampling intervals is ended, the processing module 140 determines whether a collision has occurred according to all of the acceleration variations collected within such sampling interval. Since the processing module 140 transforms the acceleration variations into the frequency domain signals under the frequency domain, and determines whether the collision has occurred according to a variation status of the frequency domain signals other than directly comparing the frequency domain signals with a predetermined threshold, a more accurate determination result can be obtained.

The invention further provides a computer program product, which is used for executing the above collision detecting method. The computer program product is basically formed by a plurality of program instruction segments (for example, setting program instruction segments or deployment program instruction segments, etc.), and after the program instruction segments are loaded into the electronic device having the accelerometer, the positioning module and the communication module for execution, the steps of the aforementioned collision detecting method can be implemented, so that the electronic device can detect collisions occurred under various circumstances such as vehicle collisions, people collided by vehicles or other objects, etc., and can opportunely send an SOS message after the collision has occurred.

In summary, according to the collision detecting method, the electronic device and the computer program products of the invention, a detected object is not limited, and after the acceleration variations are obtained, the acceleration variations are transformed into the frequency domain signals under the frequency domain, and then the energy and the entropy of the frequency domain signals are calculated to determine whether a collision has occurred. In this way, the collision occurred to a pedestrian or a vehicle can all be correctly detected. Especially, when the detected object is in a static state or a slow moving state, it can also be correctly determined whether the collision has occurred. Therefore, not only accuracy for determining the collision is improved, but also a message carrying the position information can be opportunely sent when the collision is detected, so as to shorten a time for post-treatment personnel such as rescue personnel arriving the accident scene.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A collision detecting method, adapted to an electronic device having an accelerometer, a positioning module, and a communication module, and the collision detecting method comprising:
obtaining a plurality of acceleration variations within each of a plurality of sampling intervals respectively detected by the accelerometer;
for each of the sampling intervals, transforming the corresponding acceleration variations into a plurality of frequency domain signals under a frequency domain and calculating energy and entropy of the frequency domain signals; and
determining a collision has occurred when the energy and the entropy corresponding to each of a plurality of specific sampling intervals among the sampling intervals both drastically increase then drastically decrease suddenly.

2. The collision detecting method as claimed in claim 1, further comprising:
determining whether a number of the sampling intervals is greater than or equal to 3;
taking latest three adjacent sampling intervals among the sampling intervals as the specific sampling intervals when the number of the sampling intervals is greater than or equal to 3; and
determining whether the energy and the entropy corresponding to each of the specific sampling intervals both drastically increase then drastically decrease suddenly.

3. The collision detecting method as claimed in claim 2, wherein the latest three adjacent sampling intervals are respectively an (i−1)^{th} sampling interval, an i^{th} sampling interval and an (i+1)^{th} sampling interval, and i is a positive integer greater than 1, and the step of determining whether the energy and the entropy corresponding to each of the specific sampling intervals both drastically increase then drastically decrease suddenly comprises:
calculating a first statistic value according to the energy corresponding to the (i−1)^{th} sampling interval and the energy corresponding to the (i+1)^{th} sampling interval;
calculating a second statistic value according to the entropy corresponding to the (i−1)^{th} sampling interval and the entropy corresponding to the (i+1)^{th} sampling interval;
determining whether the energy corresponding to the i^{th} sampling interval is greater than a first threshold, and whether the entropy corresponding to the i^{th} sampling interval is greater than a second threshold; and
if yes, determining the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic, and an increasing rate between the entropy corresponding to the i^{th} sampling interval and the entropy corresponding to the (i−1)^{th} sampling interval is greater than a third threshold.

4. The collision detecting method as claimed in claim 1, wherein the step of transforming the corresponding acceleration variations into the frequency domain signals under the frequency domain for each of the sampling intervals comprises:
executing a time domain/frequency domain transform process to the acceleration variations to generate the frequency domain signals.

5. The collision detecting method as claimed in claim 4, wherein the time domain/frequency domain transform process comprises one of a Fourier transform process, a cosine transform process, a sine transform process and a wavelet transform process.

6. The collision detecting method as claimed in claim 1, wherein the adjacent sampling intervals among the sampling intervals are partially overlapped.

7. The collision detecting method as claimed in claim 1, wherein after the step of determining the collision has occurred, the collision detecting method further comprises:
obtaining position information of the electronic device through the positioning module; and
sending a message carrying the position information through the communication module.

8. An electronic device, comprising:
an accelerometer;
a positioning module;
a communication module; and
a processing module, coupled to the accelerometer, the positioning module and the communication module, for obtaining a plurality of acceleration variations within each of a plurality of sampling intervals respectively detected by the accelerometer, for each of the sampling intervals, transforming the corresponding acceleration variations into a plurality of frequency domain signals under a frequency domain and calculating energy and entropy of the frequency domain signals, and determining that a collision has occurred when the energy and the entropy corresponding to each of a plurality of specific sampling intervals among the sampling intervals both drastically increase then drastically decrease suddenly.

9. The electronic device as claimed in claim 8, wherein the processing module determines whether a number of the sampling intervals is greater than or equal to 3, takes latest three adjacent sampling intervals among the sampling intervals as the specific sampling intervals when the number of the sampling intervals is greater than or equal to 3, and determines whether the energy and the entropy corresponding to each of the specific sampling intervals both drastically increase then drastically decrease suddenly.

10. The electronic device as claimed in claim 9, wherein the latest three adjacent sampling intervals are respectively an (i−1)^{th} sampling interval, an i^{th} sampling interval and an (i+1)^{th} sampling interval, and i is a positive integer greater than 1, the processing module calculates a first statistic value according to the energy corresponding to the (i−1)^{th} sampling interval and the energy corresponding to the (i+1)^{th} sampling interval, calculates a second statistic value according to the entropy corresponding to the (i−1)^{th} sampling interval and the entropy corresponding to the (i+1)^{th} sampling interval, and determines whether the energy corresponding to the i^{th} sampling interval is greater than a first threshold, and whether the entropy corresponding to the i^{th} sampling interval is greater than a second threshold,
if yes, the processing module determines the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic value, and an increasing rate between the entropy corresponding to the i^{th} sampling interval and the entropy corresponding to the (i−1)^{th} sampling interval is greater than a third threshold.

11. The electronic device as claimed in claim 8, wherein the processing module executes a time domain/frequency domain transform process to the corresponding acceleration variations to generate the frequency domain signals for each of the sampling intervals.

12. The electronic device as claimed in claim 11, wherein the time domain/frequency domain transform process comprises one of a Fourier transform process, a cosine transform process, a sine transform process and a wavelet transform process.

13. The electronic device as claimed in claim 8, wherein the adjacent sampling intervals among the sampling intervals are partially overlapped.

14. The electronic device as claimed in claim 8, wherein after the processing module determines that the collision has occurred, the processing module controls the positioning module to obtain position information of the electronic device, and controls the communication module to send a message carrying the position information.

15. A computer program product, comprising at least one program instruction, the at least one program instruction being located into an electronic device having an accelerometer, a positioning module, and a communication module for executing following steps:
obtaining a plurality of acceleration variations within each of a plurality of sampling intervals respectively detected by the accelerometer;
for each of the sampling intervals, transforming the corresponding acceleration variations into a plurality of frequency domain signals under a frequency domain and calculating energy and entropy of the frequency domain signals; and
determining a collision has occurred when the energy and the entropy corresponding to each of a plurality of specific sampling intervals among the sampling intervals both drastically increase then drastically decrease suddenly.

16. The computer program product as claimed in claim 15, wherein the at least one program instruction further determines whether a number of the sampling intervals is greater than or equal to 3, takes latest three adjacent sampling intervals among the sampling intervals as the specific sampling intervals when the number of the sampling intervals is greater than or equal to 3, and determines whether the energy and the entropy corresponding to each of the specific sampling intervals both drastically increase then drastically decrease suddenly.

17. The computer program product as claimed in claim 16, wherein the latest three adjacent sampling intervals are respectively an (i−1)^{th} sampling interval, an i^{th} sampling interval and an (i+1)^{th} sampling interval, and i is a positive integer greater than 1, the at least one program instruction calculates a first statistic value according to the energy corresponding to the (i−1)^{th} sampling interval and the energy corresponding to the (i+1)^{th} sampling interval, calculates a second statistic value according to the entropy corresponding to the (i−1)^{th} sampling interval and the entropy corresponding to the (i+1)^{th} sampling interval, determines whether the energy corresponding to the i^{th} sampling interval is greater than a first threshold, and whether the entropy corresponding to the i^{th} sampling interval is greater than a second threshold; and
if yes, the at least one program instruction determines the energy and the entropy corresponding to each of the specific sampling intervals both drastically increase then drastically decrease suddenly if the energy corresponding to the i^{th} sampling interval is greater than the first statistic value, the entropy corresponding to the i^{th} sampling interval is greater than the second statistic value, and an increasing rate between the entropy corresponding to the i^{th} sampling interval and the entropy corresponding to the (i−1)^{th} sampling interval is greater than a third threshold.

18. The computer program product as claimed in claim 15, wherein the at least one program instruction executes a time domain/frequency domain transform process to the acceleration variations to generate the frequency domain signals.

19. The computer program product as claimed in claim 18, wherein the time domain/frequency domain transform process comprises one of a Fourier transform process, a cosine transform process, a sine transform process and a wavelet transform process.

20. The computer program product as claimed in claim 15, wherein the adjacent sampling intervals among the sampling intervals are partially overlapped.

21. The computer program product as claimed in claim 15, wherein after the at least one program instruction determines that the collision has occurred, the at least one program instruction further obtains position information of the electronic device through the positioning module, and sends a message carrying the position information through the communication module.
